(19) United States
(12) Patent Application Publication
(10) Pub. No.: US 2008/0071783 A1
(43) Pub. Date: Mar. 20, 2008

(54) System, Apparatus, And Methods For Pattern Matching

(76) Inventors: Benjamin Langmead, Silver Spring, MD (US); Kenneth M. Mackenzie, Atlanta, GA (US); Steven K. Reinhardt, Vancouver, WA (US); Richard A. Lethin, New York, NY (US)

Correspondence Address: HELLER EHRMAN LLP, 4350 LA JOLLA VILLAGE DRIVE #700, 7TH FLOOR, SAN DIEGO, CA, 92122, US

(21) Appl. No.: 11/766,704

(22) Filed: Jun. 21, 2007

Related U.S. Application Data
(60) Provisional application No. 60/817,704, filed on Jul. 3, 2006.

(51) Int. Cl. G06F 17/30

(52) U.S. Cl. 707/6; 707/E17.014

(57) ABSTRACT

A computer software product, methods and apparatus for target report generation are provided. In one embodiment, a trigger pattern is derived from at least one target pattern. Locations within a data set containing the trigger pattern are identified and a target report is generated. In another embodiment, a computing apparatus is provided that produces reports by deriving a trigger pattern, identifying locations within a dataset where the trigger patterns exist and generating a report. In a further embodiment, a computer software product is provided that configures an apparatus to generate a target report. This Abstract is provided for the sole purpose of complying with the Abstract requirement rules that allow a reader to quickly ascertain the subject matter of the disclosure contained herein. This Abstract is submitted with the explicit understanding that it will not be used to interpret or to limit the scope or the meaning of the claims.

### CROSS REFERENCE TO RELATED APPLICATIONS

The present application claims priority to U.S. Provisional Application No. 60/817,704 titled “MITIGATING STATE-SPACE EXPLOSION FOR MATCHING REGULAR EXPRESSIONS” filed Jul. 03, 2006 it is hereby incorporated by reference in its entirety.

### FIELD OF THE INVENTION

The present invention generally concerns pattern matching. More particularly, the invention concerns a system, methods, and apparatus for identifying a target pattern in data.

### BACKGROUND OF THE INVENTION

In modern data communication systems there are instances where targets in data patterns may indicate events that should be evaluated. For example, data streams that pose threats such as computer viruses, trojans, or intrusion attempts may take a patterned form. Identification of these types of patterns is advantageous to prevent a security breach which might result in the theft of information or other malicious action. Further, users may want to identify documents on a network that include specific strings. For example, a company may wish to restrict information they consider to be “trade secret” to a select group of users. Additionally, they may wish to prevent email from leaving their servers if it contains references to specific programs or projects. At the core of these uses is pattern identification. Identifying target patterns presents significant space and computational problems. Identification is usually accomplished with a pattern matcher.

A pattern matcher is a system that identifies instances of patterns in a match-text. The match-text may be, for example, a string of zero or more characters. The type of patterns that the matcher can identify depends on the type of matcher used. For examples, patterns may be strings of one or more characters. In some instances, patterns of interest, herein referred to as “target patterns”, may be what is commonly known in the art as regular expressions (“Regexes”).

An example of such a system is a network intrusion detection system, or “NIDS”. A NIDS is a system that examines computer network traffic as it passes through a network link, usually in order to detect traffic that is known to be malicious. Other traffic-examining technologies such as traditional firewalls are strictly concerned with network packet headers, which contain a relatively small amount of control information about the packet. NIDS systems additionally perform pattern-matching on network packet payloads, which contain the data being exchanged by the end-points. Most of the bytes that are exchanged between end-points on the Internet are payload bytes. In practice, this means that a NIDS must be able to perform pattern matching using the payloads of passing packets as the match-text, and it must be able to find pattern instances quickly enough to keep pace with the rate of passing traffic.

To meet these requirements, many modem NIDS utilize state-machine-based setwise pattern matching. In state-machine-based pattern matching, the set of trigger patterns are rendered into a deterministic finite automaton (also known as a “DFA” or a “deterministic state machine”). Patterns can be rendered into DFA form using techniques such as those described in (A. V. Aho, R. Sethi, and J. D. Ullman. Compilers, Principles, Techniques, and Tools. Addison-Wesley Publishing Company, Reading, Mass., 1985.).

Having the target pattern(s) in DFA form enables time-efficient pattern matching in two ways: first, the work that must be done per match-text character is modest (a single “next state” state-machine table lookup followed by an update of a local “current state” variable) and, second, only a single traversal of the match-text is necessary to identify all instances for all patterns of interest.

Embodiments of state-machine-based pattern matchers typically comprise two hardware elements; a state memory (such as a DRAM chip or DIMM) which is loaded with a data representation of the state machine, and a processing element (such as a general-purpose processor or CPU) which performs a sequence of memory reads (“state-table lookups”) for each text character and detects when the machine enters a “match state”. When the processing element detects that a match state has been entered, it constructs a match report that identifies the match state and which input character caused the transition. An example of a state-machine-based pattern matcher that uses special-purpose hardware as the processing element is presented in (M. Aldwairi, T. Conte, P. Franzon, Configurable String Matching Hardware for Speeding up Intrusion Detection, in SIGARCH, Vol. 33, No. 1, March 2005). State-machine-based setwise pattern matchers are a central feature of many modern NIDS implementations in academia and in the network security industry.

However, a problem arises when a state-machine-based setwise pattern matcher allows regexes as patterns of interest. Rendering regexes into a state machine often result in a machine that is intractably large, i.e., its data representation is too large to fit into the available state-machine memory. This concern is valid no matter what type of pattern is allowed, but the problem is particularly pronounced for regexes. This is because the state-machine resulting from the combination of two regexes can have, in the worst case, a number of states equal to the product of the number of states that each regex would yield if rendered into separate regexes. This is the “regex state-space explosion problem”.

The key feature of a regex that makes it susceptible to state-space explosion is the repetition operator. A repetition operator instructs the matcher to match anywhere from X to Y instances of its operand, where X and Y can be any integers greater than or equal to 0, and its operand can be any regex. In the case of a PCRE (Perl-compatible regular expression), repetition operators are *, +, {X,Y}, and ?. Repetition operators contribute much more heavily to state-space explosion than other regex operators. In general, higher X and Y bounds and more complex operands lead to greater blowup.

A naive solution to the regex state-space explosion problem is to render each target pattern into a separate DFA and to execute the pattern matcher once per target per input string. This mitigates the state-space explosion problem by avoiding the blowup that results from combining two or more DFAs, but this comes at the expense of efficiency. The amount of matching work that must be done overall is multiplied by the number of patterns. Considering that the target patterns in a modern NIDS typically number in the thousands, this approach is too inefficient to be feasible.

### PREVIOUS WORK

U.S. Pat. No. 6,880,087 proposes a state-machine-based system for matching target patterns and identifies this technique's chief advantage: each input character is examined only once, eliminating much of the work required by multi-pass techniques such as Bayer-Moore. However, when applied to pattern sets that includes regular expressions, this technique suffers from the state-space explosion problem. This invention addresses the explosion problem while keeping processing overhead to a minimum.

U.S. Pat. No. 6,952,694 proposes a tree-based system for matching target patterns. In the embodiment described in the patent, the system contains two processing elements that perform the matching operation in tandem. The first processor checks whether the current character in the input stream corresponds to a possible “root” character for one of the patterns in the tree. If so, the first processor requests that the second processor examine the subsequent characters while simultaneously traversing the tree. This technique is limited in two ways. First, it requires at least two processing elements to be involved in the matching process. Second, for pattern sets of, say, N patterns, it requires either N+1 processing elements or N passes over the data with two processing elements. Furthermore, the amount of work (i.e. number of compare operations) that must be performed per character of input is proportional to the number of patterns. This invention is an extension of the state-machine-based pattern matching technique, which is a substantial performance improvement over the tree-based technique in U.S. Pat. No, 6,952,694.

U.S. Pat. No, 6,792,546 describes an intrusion detection system wherein target patterns are used to describe sequences of packet events, rather than characters in a traffic flow. Such a system requires a an “intrusion detection sensor” (a component of the system mentioned in Claims 1, 3, 17, 18 and 25 of U.S. Pat. No. 6,792,546) that is responsible for matching multiple target patterns simultaneously, just as in a NIDS. Though this technique uses “events” as the fundamental unit of information (rather than characters), the principle the same, and the invention proposed herein has utility as an extension that enables matching a larger number of patterns simultaneously with minimal performance sacrifice.

In many of these and other contexts it would be useful to have an improved pattern matcher. Therefore there exists a need for a system, methods, and apparatus for improved target report generation.

### SUMMARY OF THE INVENTION

The present invention provides a system, apparatus and methods for overcoming some of the difficulties presented above. In an exemplary embodiment, a method of producing a target report is provided. In this method a trigger pattern is derived from a pattern of interest or “target pattern”. The derivation of the trigger pattern includes splitting the target pattern, at least once, into disjoint sub-patterns. The trigger pattern is then used to identify a location within a dataset where the trigger pattern occurs. A target report is then derived from the data and location(s) where the trigger pattern was identified. In this embodiment, a first process is employed to identify the location(s) of the trigger pattern, and a second process is used to derive the target report. In an exemplary embodiment the second process comprises matching additional non-trigger sub-patterns derived from the target pattern.

In another embodiment, a computing apparatus is provided. The computing apparatus includes a processor, a memory and a storage media. In this embodiment, the storage media contains a set of machine executable instructions that, when executed by the processor configure the computing apparatus to produce a target report. The configuration includes defining a trigger pattern by splitting, at least once, a target pattern into disjoint sub-patterns, identifying at least one location where the trigger pattern occurs within a set of data, and using the target pattern and the location(s) defining a target report. In an exemplary embodiment the second process comprises matching additional non-trigger sub-patterns derived from the target pattern. One feature of this embodiment is that the computing apparatus may identity the presence of target pattern(s) within an incoming data set on a network.

In a further embodiment, a computer software product is provided. The computer software product includes a storage medium that contains a set of computer executable instructions that, when executed by a computing apparatus configure the apparatus to produce a target report. The configuration includes defining a trigger pattern by splitting a target pattern into disjoint sub-patterns. The configuration then identifies location(s) where the target pattern is found in a data set. The configuration then produces a target report by identifying instances where the target pattern is found by using the predefined locations.

One feature of this embodiment is that it the storage medium may be a portable media such as a CD, CDRW, DVD or optical media. Additionally, the storage media may be a hard drive or other non-volatile media stored on an apparatus on a network.

### BRIEF DESCRIPTION OF THE DRAWINGS

Various embodiments of the present invention taught herein are illustrated by way of example, and not by way of limitation, in the figures of the accompanying drawings, in which:

FIG. 1 illustrates the flow of a method of producing a target report consistent with provided embodiments;

FIG. 2 illustrates the flow of a method of producing a target report consistent with provided embodiments;

FIG. 3 illustrates the flow of a method of producing a target report consistent with provided embodiments

FIG. 4 is a block diagram of a computing apparatus consistent with provided embodiments;

FIG. 5 is another block diagram of a computing apparatus consistent with provided embodiments; and

FIG. 6 is an exemplar of various aspects of the provided embodiments.

It will be recognized that some or all of the Figures are schematic representations for purposes of illustration and do not necessarily depict the actual relative sizes or locations of the elements shown. The Figures are provided for the purpose of illustrating one or more embodiments of the invention with the explicit understanding that they will not be used to limit the scope or the meaning of the claims.

### DETAILED DESCRIPTION OF THE INVENTION

In the following paragraphs, the present invention will be described in detail by way of example with reference to the attached drawings. While this invention is capable of embodiment in many different forms, there is shown in the drawings and will herein be described in detail specific embodiments, with the understanding that the present disclosure is to be considered as an example of the principles of the invention and not intended to limit the invention to the specific embodiments shown and described. That is, throughout this description, the embodiments and examples shown should be considered as exemplars, rather than as limitations on the present invention. Descriptions of well known components, methods and/or processing techniques are omitted so as to not unnecessarily obscure the invention. As used herein, the “present invention” refers to any one of the embodiments of the invention described herein, and any equivalents. Furthermore, reference to various feature(s) of the “present invention” throughout this document does not mean that all claimed embodiments or methods must include the referenced feature(s).

As discussed above, efficient identification of patterns of interest (“target patterns”) is important to modern data communications network. In many instances, malicious software also known as “malware” may be detected by deterministic data patterns. It is important to note the exemplary application of producing a target report is presented herein in the context of malware. Other uses of target identification are known. Therefore, aspects of the invention are not limited to producing a target report with respect to virus, trojan, intrusion, or other malware detection.

As is known in the art, a network may employ wireless, wired, and optical media as the media for communication. Further, in some embodiments, portions of network may comprise the Public Switched Telephone Network (PSTN). Networks, as used herein may be classified by range. For example, a local area networks, wide area networks, metropolitan area networks and personal area networks. Additionally, networks may be classified by communications media, such as wireless networks and optical networks for example. Further, some networks may contain portions in which multiple media are employed. For example, in modern television distribution networks, Hybrid-Fiber Coax networks are typically employed. In these networks, optical fiber is used from the “head end” out to distribution nodes in the field. At a distribution node communications content is mapped onto a coaxial media for distribution to a customer's premises. In many environments, the internet is mapped info these Hybrid Fiber Coax networks providing high-speed internet access to customer premises through a “cable-modem”. In these types of networks, electronic devices may comprise computers, laptop computers, and servers to name a few. Some portions of these networks may be wireless through the use of wireless technologies such as a technology commonly known as “WiFi” which is currently specified by the IEEE as 802.11 and its various variants which are typically alphabetically designated as 802.11a, 802.11b, 802.11g and 802.11n to name a few.

Portions of a network may additionally include wireless networks that are typically designated as “cellular networks”. In many of these networks, Internet traffic is routed through high-speed “packet-switched” or “circuit-switched” data channels that may be associated to traditional voice channels. In these networks, electronic devices, may include cell-phones, PDA's laptop computers, or other types of portable electronic devices. Additionally, metropolitan area networks may include “WiMax” networks employing an alternate wide area, or metropolitan area wireless technology. Further personal area networks are known in the art. Many of these personal area networks employ a frequency-hopping wireless technology known in the industry as “Bluetooth” others personal area networks may employ a technology known as Ultra-Wideband (UWB). The hallmark of personal area networks is their limited range, and in some instances very high data rates. Since many types of networks and underlying communication technologies are known in the art, various embodiments of the present invention will not therefore be limited with respect to the type of network or the underlying communication technology.

For purposes of clarity the term network as used herein specifically includes but is not limited to the following networks: a wireless communication network, a local area network, a wide area network, a client-server network, a peer-to-peer network, a wireless local area network, a wireless wide area network, a cellular network, a public switched telephone network, and the Internet.

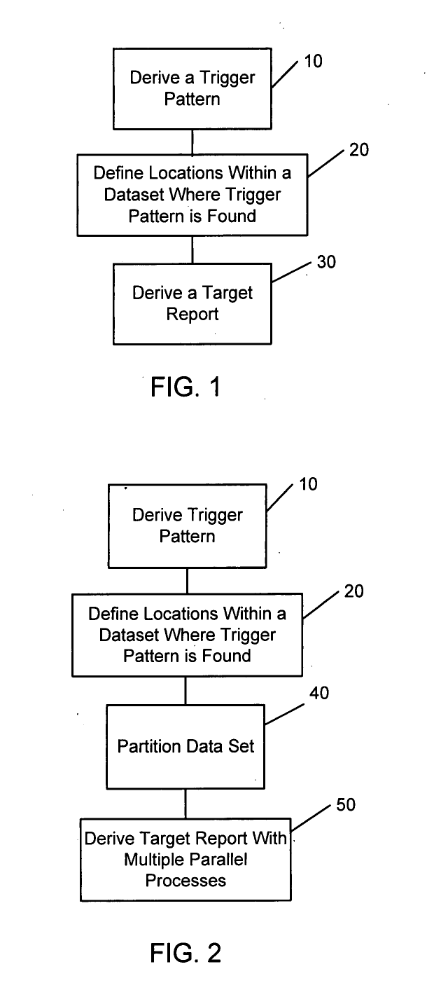

Referring to FIG. 1, which illustrates an exemplary embodiment of a method of target report generation. Flow begins in block 10 where a trigger pattern is derived from a target pattern. In some embodiments, a plurality of trigger patterns are derived from more than one target pattern. One feature of these embodiments, is that they allow for identification of multiple target patterns. Flow continues to block 20 where the locations within a data set where the trigger pattern(s) are found are defined. A target report is then derived for the data based on the locations and the target pattern. In embodiments where there are multiple target patterns and multiple trigger patterns, the target report may include instances of each target pattern.

In an exemplary embodiment, trigger patterns are derived through a process of splitting the target pattern into disjoint sub-patterns. The trigger patterns are then loaded info a first process that identifies locations where the trigger patterns are found. An exemplary first process is a single pass pattern matching process such as a state machine. In one embodiment the first process employs a Deterministic Finite Automaton (DFA). As is known in the art, a DFA is a state machine where for each pair of state and input symbols there is one and only one transition to a next state. For example, a DFA may operate on a string of input symbols. The DFA begins in a first state, and for each input symbol transitions to a state defined by a transition function. When the DFA enters a match state, the location in the data where the match occurred in recorded for later processing. In some embodiments, the trigger pattern is shorter than the target pattern.

In another embodiment, the first process employs a Non-Deterministic Finite Automaton (NFA). As is known in the art, a NFA is a state machine where for each pair of state and input symbols there may be several possible next states. Further, in some instances NFAs may transition to multiple next states when uncertainty exists in transition. NFAs may additionally transition from a particular state without an additional input under certain conditions. Another distinction between DFAs and NFAs is that in NFAs the next state depends not only on the current state and the input, but may also depend on a number of subsequent input events. Until these subsequent events are resolved it is not possible to determine which state the NFA is in.

in some embodiments, the trigger pattern is derived by splitting target pattern into disjoint sub-patterns by employing a splitting policy. In an exemplary embodiment the splitting operation comprises isolating complex sub-patterns. In this embodiment, sub-patterns that are identified for isolation by the splitting policy are termed “splittable sub-patterns”. This invention is indifferent to the particular splitting policy employed. In one embodiment, the splitting policy may be “isolate all sub-patterns where a repetition operator is applied to a non-character sub-pattern and one of the repetition's bounds is greater than 5”. According to this policy, a sub-pattern (abc){1,10} (the string “abc” repeated anywhere from 1 to 10 times) would be isolated via splitting, but not sub-patterns (abc){1,4} (the string “abc” repeated from 1 to 4 times) or a{1,10} (the character “a” repeated from 1 to 10 times).

Once splittable sub-patterns have been identified, they are removed from their parent pattern. Removing a particular sub-pattern deletes the sub-pattern from the parent pattern; if the sub-pattern was neither a prefix nor a suffix of the parent pattern, then the parent pattern becomes divided into two pieces as a result of this deletion. The piece that preceded the removed sub-pattern is the “left-hand-side” and the piece that followed the removed sub-pattern is the “right-hand-side”, if the sub-pattern was a prefix of a parent pattern then the remainder of the parent pattern is the right-hand-side and there is no resulting left-hand-side. If the sub-pattern was a suffix of a parent pattern then the remainder of the parent pattern is the left-hand-side and there is no resulting right-hand-side. For example, if the sub-pattern “a{1,10}” is split from the pattern “cra{1,10}fty”, then the resulting left-hand-side is “cr” and the resulting right-hand-side is “fty”. If the sub-pattern “(at){1,10}” is split from the pattern “(at){1,10}tack”, then the resulting right-hand-side is “tack” and there is no resulting left-hand-side.

In some embodiments splitting is applied recursively; i.e., a sub-pattern that was previously isolated via splitting is treated as a parent pattern whose sub-patterns are potentially splittable. For example, the splitting policy may dictate that the pattern “a(b[cd]{1,100}e{1,100}f” be split by removing the sub-pattern “b[cd]{1,100}e” yielding left- and right-hand sides “a” and “f”. Then, the splitting policy might further dictate that the sub-pattern “b[cd]{1,100}e” be recursively split by removing the sub-pattern “[cd]” yielding left- and right-hand sides ‘b’ and ‘e’.

Also note that in some embodiments, splitting is applied to the left- and right-and-sides of a parent pattern that was previously split. For example, the pattern “a[bc]{1,100}c[de]{1,100}f” may be split by isolating the sub-pattern “[bc]{1,100}” yielding left- and right-hand sides “a” and “c[de]{1,100}f”. Then, the right-hand side may be further split by isolating the sub-pattern “[de]{1,100}” yielding left- and right-hand sides “c” and “f”.

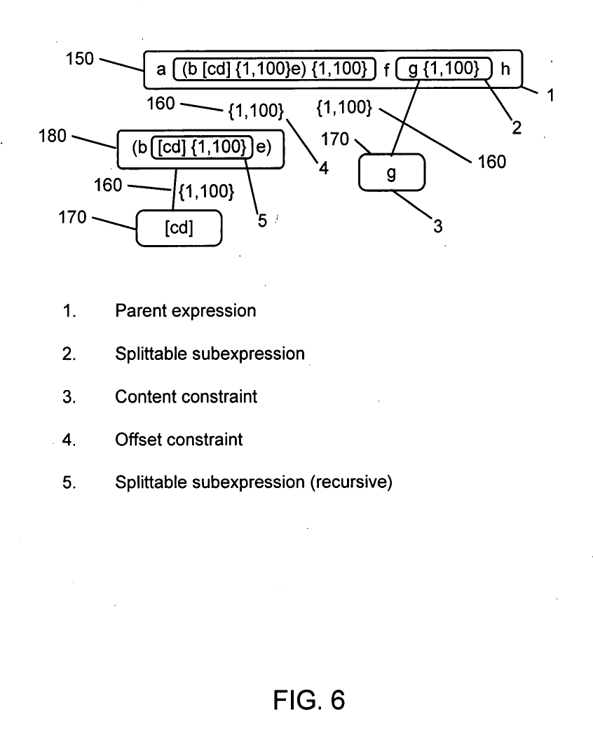

In one embodiment illustrated in FIG. 6, the cumulative set of splitting decisions made with respect to a particular parent pattern is represented by a “splitting tree”. The root node 150 of the tree represents the parent pattern 1. In each instance where a pattern was split, a parent/child link 160 exists between the parent pattern and the child sub-pattern 170 that was removed. An example of a splitting tree for the pattern “a(b[cd]{1,100}e){1,100}fg{1,100}h” given a splitting policy of “remove all sub-patterns where a repetition operator is applied to any sub-pattern and one of the repetition's bounds is greater than 10”. Since the splitting policy is recursive in some embodiments, some nodes like node 180 may be both a parent node and a child node 170.

In the illustrated embodiment, constraints may be additionally derived from splitting the target pattern. As used herein, constraints may be classified in a number of manners. For example, a content constraint, such as constraint 3 may encode a sub-pattern that must match in order for the target pattern to be present. An offset constraint, such as constraint 4 may encode a range of relative match offsets. In the illustrated embodiment, constraint 4 may indicate a range from 1 to 100 instances.

Returning to FIG. 1, in block 30 a target report is generated. In one embodiment, the target report is generated by a second process that uses the target and the locations identified in the first process. In some embodiments, the second process may additionally use constraints generated in the splitting process to identify when the target pattern is found in the data. For example, in the above embodiment, in each instance where a pattern is split, a pair of constraints is derived: an offset constraint 4 and a content constraint 5. As stated above, the offset constraint 4 encodes the relative match offsets that the left-hand and right-hand sides of the pattern must have in order for it to be possible for the overall pattern to match. For example, if the pattern is a[b]{1,100}c, then the offset constraint may be represented as the pair (1,100), meaning “if the difference in offset between occurrences of c and a is in the range [1, 100], then the constraint is satisfied.” The content constraint encodes the regular expression that must match the characters that make up the span of the match text between the instances of the left- and right-hand sides of the original pattern (called the match span). For example, if the pattern is a[b]*c, and the removed sub-pattern is [b]*, then the content constraint dictates that the match span must match the regex [b]*.

The invention is indifferent to the manner in which the offset and content constraints are encoded. In one embodiment, the offset constraint may be a pair of integers indicating the range of allowable differences between the positions of the first characters of the occurrences of the left- and right-hand-sides. In another embodiment, offset may be measured from the final characters of the occurrences. The invention is also indifferent to the manner in which the offset constraint is checked.

The invention is also indifferent to the manner in which the content constraints are represented and checked. In one embodiment, the content constraints may be represented as a regular expression string and checked by a simple, backtracking, single pattern matcher. In another embodiment, the content constraints may be represented by a DFA and checked by a state-machine-based pattern matcher.

One feature of the present invention is that it provides a system and methods for pattern matching. In one embodiment, the patterns are regular expressions. As is known in the art, the term “regular expression” refers to expressions that describe sets of strings. They are usually used to give a concise description of a set, without having to list all elements. For example, the set containing the three strings Handel, Händel , and Haendel can be described by the pattern “H(ä|ae?)ndel” (or alternatively, it is said that the pattern matches each of the three strings). Aspects and embodiments of the present invention are directed towards regular expressions while other embodiments are not so directed. Therefore, some of the various provided embodiment are not limited with respect to regular expressions.

In some embodiments, deriving a target report comprises processing portions of the data that contain the trigger pattern with a sequential matcher. As is known in the art, sequential matchers may include backtracking mechanisms to match target patterns.

In an exemplary embodiment, shown in FIG. 2, the operational flow of a target report generator is illustrated. In this embodiment, similar in some respects to the above discussed embodiments, flow begins in block 10 where a target pattern is derived. In some target report generators, the target pattern is actually one of a plurality of target patterns and the trigger pattern may be derived from more than one target pattern. In other embodiments, the trigger pattern may comprise a plurality of trigger patterns, each derived from one or more target patterns. In block 20 locations in a data pattern where trigger patterns are found are identified. Like the above embodiments, the identification may be accomplished by a number of processes. In block 40 a dataset to be processed may be partitioned into data subsets and in block 50 a target report is derived from at least one of the subsets by parallel processes. In another embodiment, instances of the trigger pattern are partitioned into subsets in block 40. In this embodiment, the dataset may be processed by parallel processes, each processing one or more instances of the trigger pattern. Like the previous embodiment, illustrated in FIG. 1, the report generation in block 50 may comprise the use of the locations found in block 20, portions of the trigger pattern and, in some instances, additional sub-patterns derived from the trigger pattern.

In some parallel processes there may be data, state, or other dependencies between processes. In one embodiment, these potential dependencies are identified prior to the process of report generation. In this manner scheduling may be employed to ensure conflicts are resolved prior to report generation processing. For example, where a trigger pattern has been identified near the beginning or ending of a subset and the report generation mechanism employs techniques that need to look ahead or behind, a first parallel processor may be using the data when a second processor needs to access it. In this case the data dependency can be resolved by scheduling the first and second processes to work sequentially.

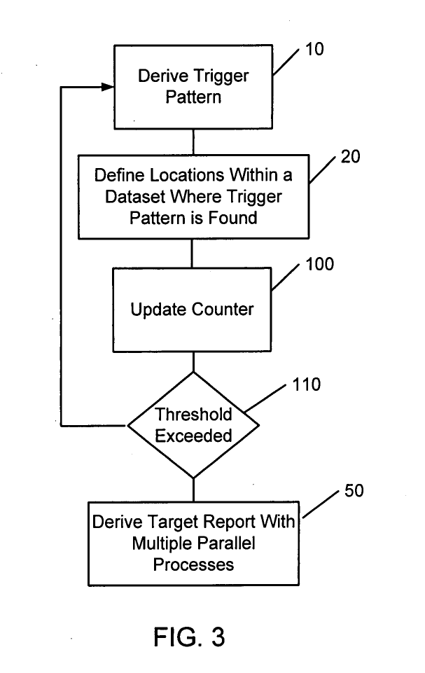

The flow of another exemplary embodiment is illustrated in FIG. 3. In this embodiment, similar to above embodiments, flow begins in block 10 where a trigger pattern is derived. Flow proceeds to block 20 where a first process, such as those discussed above, identifies locations within a dataset where the target pattern is found. In block 100 a counter is updated. Flow proceeds to decision block 110, where the counter is compared to a threshold. If the counter exceeds the threshold flow proceeds back to block 10 where the trigger pattern is redefined. Returning to block 110 if the counter does not exceed the threshold flow proceeds to block 50 where a target report is generated. Like the above embodiments, the derivation of a target report comprises a process utilizing the locations identified in block 20, and in some instances, other non-trigger patterns derived from the target pattern.

One feature of this embodiment is that it allows for significant flexibility and control over the calculational complexity of the first process. For example, if a counter is increased for every instance of a trigger pattern, and a second process must look at every instance, a number of “false positives” may be generated if the trigger pattern is too short or in other ways inefficient. This is especially the case where the second process does not identify the target pattern in a substantial number of indicated location. In this case the count of identified trigger patterns may indicate a need to alter the trigger pattern.

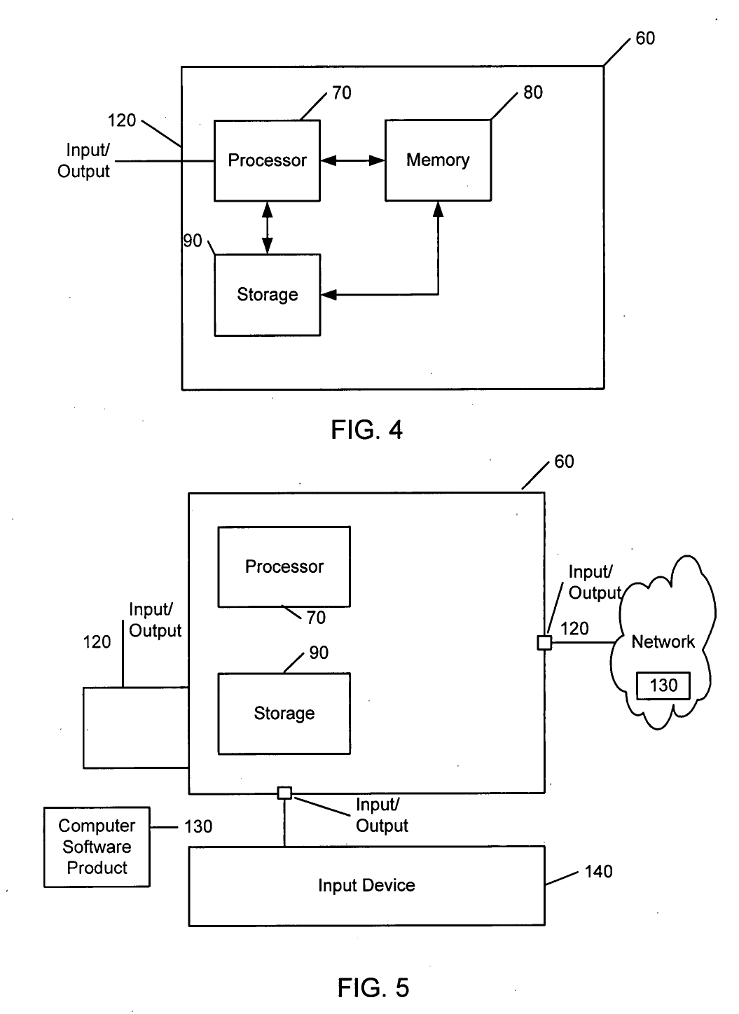

FIG. 4 illustrates an exemplary embodiment of a computing apparatus 60 provided herein. In this embodiment, computing apparatus 60 may be capable of connecting to a network through one of its input/output ports 120 (one shown for convenience). Computing apparatus 60 comprises a processor 70, a memory 80 a storage media 90. As is known in the art, computing apparatus 60 may include additional components which are not illustrated for convenience. Processor 70 may comprise any general purpose processor or in some embodiments, may be a digital signal processor or an application specific processor, possibly including special-purpose pattern-matching features. A number of memory 80 technologies are known in the art and may be used to practice the current invention, therefore embodiments are not limited by the specific memory 80 used. In one embodiment, computing apparatus 60 is a server in a client-server network. In this embodiment, storage media 90 may further include a database where target patterns may be stored. In some embodiments the database is located within computing apparatus 60 or may be located on another device on a network and accessed from input/output port 120. Storage media 90 contains a set of machine executable instructions that when executed by processor 70 configures computing apparatus 60 to generate a target report. The methods of target report generation consistent with the above discussed methods.

FIG. 5 illustrates another embodiment of computing apparatus 60 and an embodiment of a computer software product 130. In this embodiment, computing apparatus 60 is similar to the above embodiments but additionally includes an input device 140. In one embodiment, computing apparatus 60 additionally includes an input port 120 suitable for accepting a computer software product 130. As is known in the art, input port 120 may be a port for a removable hard drive, a floppy disk port, an optical disk port, a port suitable to accept a computer software product 130 that comprises a chip based memory, or other port sufficient to accept computer software product 130. In another embodiment (not shown) electronic device does not include input port 120 and computer software product 130 may comprise a storage media 90 located on a network.

In one embodiment of computer software product 130, storage media 90 may be configured to contain a set of computer executable instructions that when executed by a processor 70 configure computing apparatus 60 to generate a target report. The configuration of storage media may be accomplished by transferring, copying, or installing the computer executable instructions from computer software product 130 to storage media 90. The configuration of computing apparatus 60 consistent with the above methods for target report generation.

The present invention provides significant novel advantages over current forms of target detection and report generation. Thus, it is seen that a system, method and apparatus for target report generation are provided. One skilled in the art will appreciate that the present invention can be practiced by other than the above-described embodiments, which are presented in this description for purposes of illustration and not of limitation. The specification and drawings are not intended to limit the exclusionary scope of this patent document. It is noted that various equivalents for the particular embodiments discussed in this description may practice the invention as well. That is, while the present invention has been described in conjunction with specific embodiments, it is evident that many alternatives, modifications, permutations and variations will become apparent to those of ordinary skill in the art in light of the foregoing description. Accordingly, it is intended that the present invention embrace all such alternatives, modifications and variations as fall within the scope of the appended claims. The fact that a product, process or method exhibits differences from one or more of the above-described exemplary embodiments does not mean that the product or process is outside the scope (literal scope and/or other legally-recognized scope) of the following claims.

What is claimed is:

1. A method of producing a target report from a data set comprising:
deriving a trigger pattern from a target pattern by splitting the target pattern at least once into a plurality of disjoint sub-patterns;
defining one or more locations within a data set where the presence of the trigger pattern occurs by a process employing the trigger pattern; and
deriving a target report by determining if the target pattern exists in the data pattern at any of the one or more locations.

2. The method of claim 1, wherein the trigger pattern is shorter in length than the target pattern.

3. The method of claim 1, wherein the identification of the presence of the trigger pattern comprises employing a single-pass pattern matching mechanism.

4. The method of claim 3, wherein the single-pass pattern matching mechanism is a finite state machine.

5. The method of claim 3, wherein the single-pass pattern matching mechanism is a deterministic finite automaton.

6. The method of claim 3, wherein the single-pass pattern matching mechanism is a nondeterministic finite automaton.

7. The method of claim 1, wherein the determination if the target pattern exists comprises processing the data pattern with a sequential matcher.

8. The method of claim 7, wherein the sequential matcher comprises backtracking.

9. The method of claim 1, wherein the determination if the pattern exists comprises processing the data pattern with a plurality of parallel matchers.

10. The method of claim 9, further comprising determining if a potential conflict exists in the parallel matchers prior to deriving a target report.

11. The method of claim 10, wherein the determination of potential conflict is identified through state dependence information.

12. The method of claim 1, wherein the target pattern is one of a plurality of target patterns and a plurality of trigger patterns are derived from more than one target pattern of the plurality.

13. The method of claim 1, wherein the target pattern is a regular expression.

14. The method of claim 1, wherein the splitting follows a splitting policy.

15. The method of claim 1, wherein the splitting is performed a multiplicity of times and a splitting tree is derived, the splitting tree comprising a root node and at least one child node.

16. The method of claim 1, wherein the sub-patterns comprise at least one constraint, the at least one constraint comprises an offset constraint, the offset constraint encoding a range of acceptable relative match offsets between a left-hand and a right-hand sides of a split expression.

17. The method of claim 1, wherein the sub-patterns comprise at least one constraint, the at least one constraint comprises a content constraint, the content constraint encoding an expression that must match between left-hand and right-hand expressions.

18. The method of claim 1, further comprising updating a counter every time the trigger pattern is matched and redefining the trigger pattern if the counter exceeds a threshold.

19. The method of claim 1, further comprising updating a counter every time the target pattern is found in the data.

20. The method of claim 1, further comprising redefining the trigger pattern based on a threshold.

21. A computing apparatus comprising:
one or more processors;
a memory; and
a storage media, wherein the storage media contains a set of computer executable instructions, the computer executable instructions configuring the processor to perform pattern matching, the pattern matching configuration comprising:
deriving a trigger pattern from a target pattern by splitting the target pattern at least once info a plurality of disjoint sub-patterns;
defining one or more locations within a data set where the presence of the trigger pattern occurs by a process employing the trigger pattern; and
deriving a target report by determining if the target pattern exists in the data pattern at the one or more locations.

22. The computing apparatus of claim 21, wherein the trigger pattern is shorter in length than the target pattern.

23. The computing apparatus of claim 21, wherein the identification of the presence of the trigger pattern comprises employing a single-pass pattern matching mechanism.

24. The computing apparatus of claim 23, wherein the single-pass pattern matching mechanism is a finite state machine.

25. The computing apparatus of claim 23, wherein the single-pass pattern matching mechanism is a deterministic finite automaton.

26. The computing apparatus of claim 23, wherein the single-pass pattern matching mechanism is a nondeterministic finite automaton.

27. The computing apparatus of claim 21, wherein the determination if the target pattern exists comprises processing the data pattern with a sequential matcher.

28. The computing apparatus of claim 27, wherein the sequential matcher comprises backtracking.

29. The computing apparatus of claim 21, wherein the determination if the pattern exists comprises processing the data pattern with a plurality of parallel matchers.

30. The computing apparatus of claim 29, wherein the configuration further comprises determining if a potential conflict exists in the parallel matchers prior to deriving a target report.

31. The computing apparatus of claim 30, wherein the determination of potential conflict is identified through state dependence information.

32. The computing apparatus of claim 21, wherein the target pattern is one of a plurality of target patterns and a plurality of trigger patterns are derived from more than one target pattern of the plurality.

33. The computing apparatus of claim 21, wherein the target pattern is a regular expression.

34. The computing apparatus of claim 21, wherein the splitting follows a splitting policy.

35. The computing apparatus of claim 21, wherein the splitting is performed a multiplicity of times and a splitting tree is derived, the splitting tree comprising a root node and at least one child node.

36. The computing apparatus of claim 21, wherein the sub-patterns comprise at least one constraint, the at least one constraint comprises an offset constraint, the offset constraint encoding a range of acceptable relative match offsets between a left-hand and a right-hand sides of a split expression.

37. The computing apparatus of claim 21, wherein the sub-patterns comprise at least one constraint, the at least one constraint comprises a content constraint, the content constraint encoding an expression that must match between left-hand and right-hand expressions.

38. The computing apparatus of claim 21, wherein the configuration further comprises updating a counter every time the trigger pattern is matched and redefining the trigger pattern if the counter exceeds a threshold.

39. The computing apparatus of claim 21, wherein the configuration further comprises updating a counter every time the target pattern is found in the data.

40. The computing apparatus of claim 21, wherein the configuration further comprises redefining the trigger pattern based on a threshold.

41. A computer software product comprising:
a storage medium, the storage medium comprising a set of computer executable instructions stored thereon, the computer executable instructions suitable to configure a computing apparatus to perform pattern matching, the configuration comprising
deriving a trigger pattern from a target pattern by splitting the target pattern at least once into a plurality of disjoint sub-patterns;
defining one or more locations within a data set where the presence of the trigger pattern occurs by a process employing the trigger pattern; and
deriving a target report by determining if the target pattern exists in the data pattern at any of the one or more locations.

42. The computer software product of claim 41, wherein the trigger pattern is shorter in length than the target pattern.

43. The computer software product of claim 41, wherein the identification of the presence of the trigger pattern comprises employing a single-pass pattern matching mechanism.

44. The computer software product of claim 43, wherein the single-pass pattern matching mechanism is a finite state machine.

45. The computer software product of claim 43, wherein the single-pass pattern matching mechanism is a deterministic finite automaton.

46. The computer software product of claim 43, wherein the single-pass pattern matching mechanism is a nondeterministic finite automaton.

47. The computer software product of claim 41, wherein the determination if the target pattern exists comprises processing the data pattern with a sequential matcher.

48. The computer software product of claim 47, wherein the sequential matcher comprises backtracking.

49. The computer software product of claim 41, wherein the determination if the pattern exists comprises processing the data pattern with a plurality of parallel matchers.

50. The computer software product of claim 49, wherein the configuration further comprises determining if a potential conflict exists in the parallel matchers prior to deriving a target report.

51. The computer software product of claim 50, wherein the determination of potential conflict is identified through state dependence information.

52. The computer software product of claim 51, wherein the target pattern is one of a plurality of target patterns and a plurality of trigger patterns are derived from more than one target pattern of the plurality.

53. The computer software product of claim 51, wherein the target pattern is a regular expression.

54. The computer software product of claim 51, wherein the splitting follows a splitting policy.

55. The computer software product of claim 51, wherein the splitting is performed a multiplicity of times and a splitting tree is derived, the splitting tree comprising a root node and at least one child node.

56. The computer software product of claim 51, wherein the sub-patterns comprise at least one constraint, the at least one constraint comprises an offset constraint, the offset constraint encoding a range of acceptable relative match offsets between a left-hand and a right-hand sides of a split expression.

57. The computer software product of claim 51, wherein the trigger pattern comprises at least one constraint, the at least one constraint comprises a content constraint, the content constraint encoding an expression that must match between left-hand and right-hand expressions.

58. The computer software product of claim 51, wherein the configuration further comprises updating a counter every time the trigger pattern is matched and redefining the trigger pattern if the counter exceeds a threshold.

59. The computer software product of claim 51, wherein the configuration further comprises updating a counter every time the target pattern is found in the data.

60. The computer software product of claim 51, wherein the configuration further comprises redefining the trigger pattern based on a threshold.
